(19) United States
(12) Patent Application Publication
(10) Pub. No.: US 2021/0284423 A1
(43) Pub. Date: Sep. 16, 2021

(54) Method and Means for Releasing a Terpene Mixture to a Cannabis Flower During Storage

(71) Applicants: Mike Cowen, Mississauga (CA); Brandon Cowen, Mississauga (CA); Jordan Cowen, Toronto (CA)

(72) Inventors: Mike Cowen, Mississauga (CA); Brandon Cowen, Mississauga (CA); Jordan Cowen, Toronto (CA)

(21) Appl. No.: 17/203,704

(22) Filed: Mar. 16, 2021

Related U.S. Application Data
(60) Provisional application No. 62/989,955, filed on Mar. 16, 2020.

(51) Int. Cl. B65D 81/26; A01N 3/02; B65D 81/18; B65D 85/50

(52) U.S. Cl. CPC B65D 81/268; B65D 85/505; B65D 81/18; A01N 3/02

(57) ABSTRACT

A method and means for releasing a terpene mixture to a Cannabis flower during storage with may be from a cotton pulp card or a two-way humidity pack with an additional terpene blend for keeping a Cannabis flower fresh while naturally increasing the desired terpene levels. The product is a blend of humidity regulating agents infused with terpenes (plant derived) which allows for the product to be paired with herbal material to increase and maintain the relative humidity, while transferring the flavor/aroma/taste terpenes from the package into the herbal material. There are two embodiments, the first is a Terp Pack+Humidity (“Terp Pack+RH”) which contains a herban material to increase and maintain relative humidity, while releasing the infused terenes, and the second is more simply a Terp Pack (“Terp Pack”) which contains no humidity enhancing material and is only a carrier for releasing the terpene mixture.

### FEDERALLY SPONSORED RESEARCH

Not Applicable

### SEQUENCE LISTING OR PROGRAM

Not Applicable

### TECHNICAL FIELD OF THE INVENTION

The present invention relates generally to releasing/infusing a terpene mixture to a Cannabis flower during storage to increase desired terpene levels. More specifically, the present invention relates to a method and means for releasing a terpene mixture to a Cannabis flower during storage which may be from a cotton pulp card housed inside a breathable two-way packaging or a two-way humidity pack with an additional terpene blend for keeping a Cannabis flower or medical marijuana fresh while naturally increasing the desired terpene levels.

### BACKGROUND OF THE INVENTION

Many natural products are best stored or maintained within a controlled environment. Freshness packs or desiccants commonly found in food packaging or with consumer goods are typically designed to absorb as much moisture as possible, aka one-way humidity control. This is common with dried foods such as beef jerky or dried fruits and is also common for consumer goods such as shoes and clothing items.

With respect to undried food items which are not desired to be dried out, or must retain a specific moisture level, a two-way humidity control pack is typically used. One of the most crucial considerations is managing the relative humidity (RH) of a moist food product, plant, or other natural product while it is stored in an airtight container. Having too much moisture will increase the risk of contamination by mold or mildew as commonly found on fruits, plants, and tress.

With specific attention to the Cannabis flower, having too little moisture will cause the trichomes to dry out and become brittle, harsh, and less effective as the essential oils that carry the cannabinoids and terpenes slowly degrade. A sure sign of this effect can be measured by the volume of aroma coming off the bud into a container's headspace. That smell comes from the terpenes that are evaporating from the trichome part of the flower.

Industry standards have identified 55 to 65 percent RH to be the safest and most optimal range to store Cannabis, with some suggesting 62% to be ideal, but acknowledging that plant density and personal preference can be the determining factor in selecting a desired humidity level.

Two-way humidity control technology for Cannabis, which adds consistency and precision to the storage environment is known. Instead of just absorbing as much moisture as possible like a desiccant does, it is known that a two-way packet can precisely control the environment to a specific level of relative humidity (RH). This means that more than just eliminating moisture, two-way packets can deliver the best or preferred humidity level for a given food or natural item.

### DEFINITIONS

Cannabis is a genus of flowering plants in the family Cannabaceae.

Caryophyllene, more formally-β-caryophyllene, is a natural bicyclic sesquiterpene that is a constituent of many essential oils, especially clove oil, the oil from the stems and flowers of Syzygium aromaticum, the essential oil of Cannabis sativa, rosemary, and hops.

Limonene is a colorless liquid aliphatic hydrocarbon classified as a cyclic monoterpene and is the major component in the oil of citrus fruit peels. The D-isomer, occurring more commonly in nature as the fragrance of oranges, is a flavoring agent in food manufacturing, and also is one of the most common terpenes found in the Cannabis sativa plant.

Linalool refers to two enantiomers of a naturally occurring terpene alcohol found in many flowers and spice plants such as lavender, coriander, and the Cannabis sativa plant. These have multiple commercial applications, the majority of which are based on its pleasant scent.

Myrcene, or β-myrcene, is an alkene natural hydrocarbon. It is more precisely classified as a monoterpene. Monoterpenes are dimers of isoprenoid precursors, and myrcene is a significant component of the essential oil of several plants, including bay, Cannabis sativa, and hops.

“Terp Card” or “Terp Pack”, the Terp Pack or the Terp+RH Pack is exactly the same in all aspects except the additions of terpenes/RH ingredients are added to the latter embodiment. There is no extra card added inside the breathable packaging alongside the pulp cotton pad/card. Acting as his own lexicographer, the Inventor refers to the first embodiment of the Terpene-enhancing Humidity Pack simply “Terp Pack+RH” and the second embodiment of the Terpene Increasing Pack without RH regulators as “Terp Pack”.

### SUMMARY OF THE INVENTION

The present invention is a method and means for releasing a terpene mixture to a Cannabis flower during storage which may be from a cotton pulp card housed inside a breathable two-way packaging or a two-way humidity pack with an additional terpene blend for keeping a Cannabis flower or medical marijuana fresh while naturally increasing the desired terpene levels.

In another embodiment, the present invention improves on a traditional and well-known two-way humidity pack by adding terpene blends into the humidity pack so the moisture and terpene levels in the Cannabis flower are not only re-humidified but also get an increase in the desired terpene levels from the terpene blend.

The product is a blend of humidity regulating agents (including but not limited to organic based material) infused with terpenes (plant derived) which allows for the product to be paired with herbal material to increase and maintain the relative humidity, while transferring the flavor/aroma/taste terpenes from the package into the herbal material.

The package holding the contents is made from a polymer material allowing a two-way transference of moisture (which is readily know in the prior art) and the release of the terpenes. Packages with be available in various sizes to suit different average herb content weight.

There are two embodiments of the invention currently being contemplated by the inventors. The first is a Tern Pack+Humidity (“Terp Pack+RH”) which contains a herban material to increase and maintain relative humidity, while releasing the infused terpenes. The second is more simply a Terp Pack which contains no humidity enhancing material and is only a carrier for releasing the terpene mixture.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIGS. 1 and 3 illustrate a humidity control pack (“Terp Pack+RH”) infused with terpenes as taught by the present invention.

FIG. 2 illustrates a humidity control pack, packaged for sale, as taught by the present invention.

FIG. 4 is a test report illustrating the results of using various terpene compounds in a control sample.

FIG. 5 is a test report illustrating the results of using various terpene compound level measurements in a sample which was increased/boosted by the Terp Pack+RH invention.

FIG. 6 is a chart illustrating the results of terpene boosting.

FIGS. 7-9 illustrate specifically the pulp pad pack that is formulated with humidity regulating ingredients and terpene blends, creating a humidity control pack with terpene blends, as taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention.

Not all components are shown or illustrated in the drawings as they are well known in the art and not necessary for one of ordinary skill in the art to make or use the present invention. Drawings of these elements are necessary for the understanding of the subject matter to be patented. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

There are many elements to consider when properly curing and storing Cannabis. One of the most crucial considerations is managing the relative humidity (RH) of the plant while it is stored in an airtight container. Having too much moisture will increase the risk of contamination by mold or mildew. Having too little moisture will cause the flower and trichomes to dry out. They will become brittle, harsh, and less effective as the essential oils that carry the cannabinoids and terpenes slowly degrade.

The present invention is a method and means for releasing a terpene mixture to a Cannabis flower during storage with may be from a cotton pulp card or pack 101 or a two-way humidity pack 103 with an additional terpene blend for keeping a Cannabis flower or medical marijuana fresh while naturally increasing the desired terpene levels.

In another embodiment, the present invention is an improvement to an existing type of two-way humidity pack. The present invention improves on a traditional and well-known two-way humidity pack by adding terpene blends into the humidity pack so the moisture and terpene levels in a Cannabis flower are not only re-humidified, but also get an increase in desired terpene levels from the terpene blend.

The product of the present invention is a blend of humidity regulating agents (including but not limited to organic based material) infused with terpenes (plant derived) which allows for the product to be paired with herbal material to increase and maintain the relative humidity, while transferring the flavor/aroma/taste terpenes from the package into the herbal material.

There are two embodiments of the present invention currently being contemplated by the inventors. The first is a Terp Pack+Humidity which contains a herban material to increase and maintain relative humidity, while releasing the infused terenes. The second is more simply a Terp Pack which contains no humidity enhancing material and is only a carrier for releasing a terpene mixture.

Industry standards have identified 55 to 65 percent RH to be the safest and most optimal range to store Cannabis, with some suggesting 62% to be ideal, but acknowledging that plant density and personal preference can be the determining factor in selecting a desired humidity level.

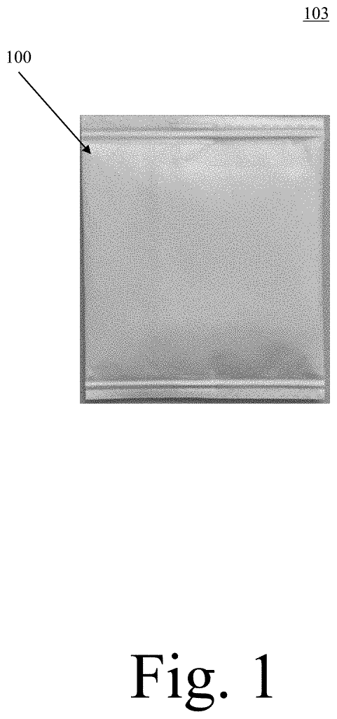

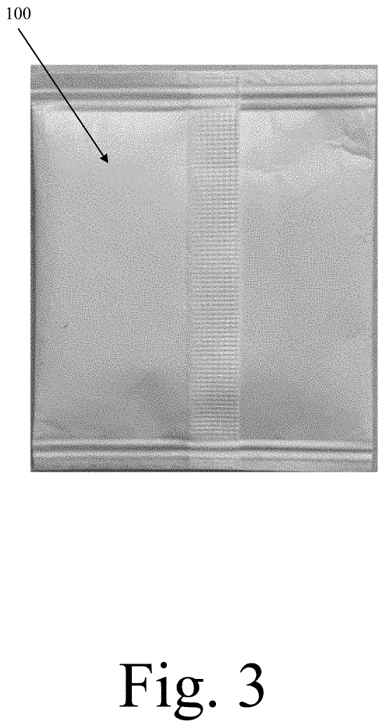

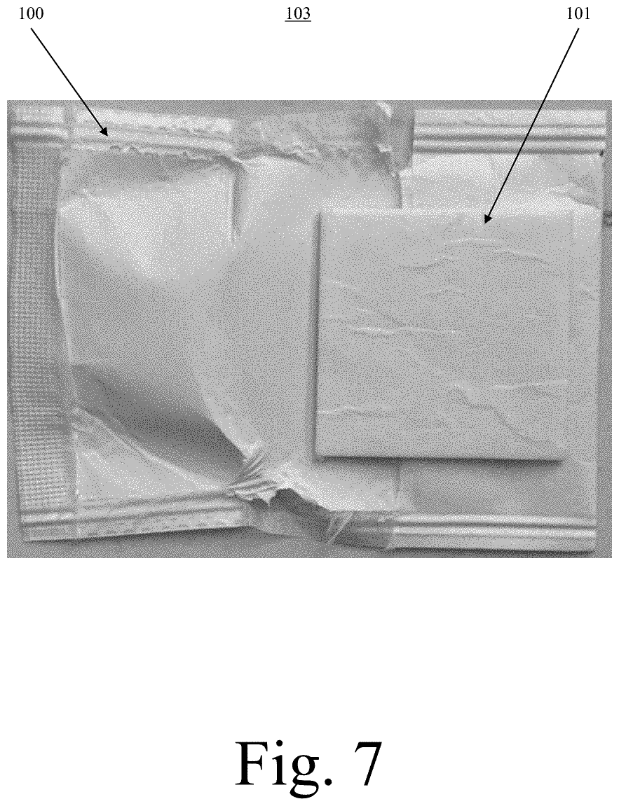

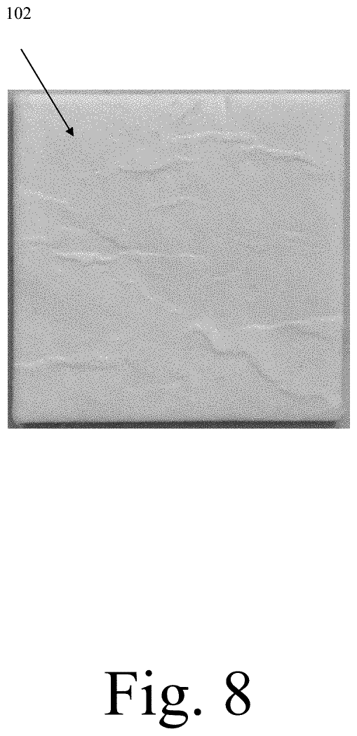

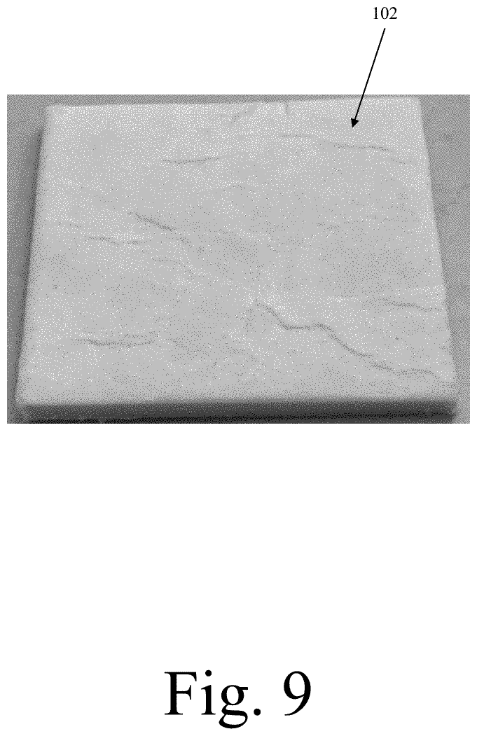

FIGS. 1 and 3 illustrate a humidity control pack (“Terp Pack+RH”) infused with terpenes as taught by the present invention. FIGS. 7-9 illustrate specifically the pulp pad pack that is formulated with humidity regulating ingredients and terpene blends, creating a humidity control pack with terpene blends, as taught by the present invention.

FIGS. 1 and 3 illustrate a humidity control pack (“Terp Pack+RH”) infused with terpenes as taught by the present invention.

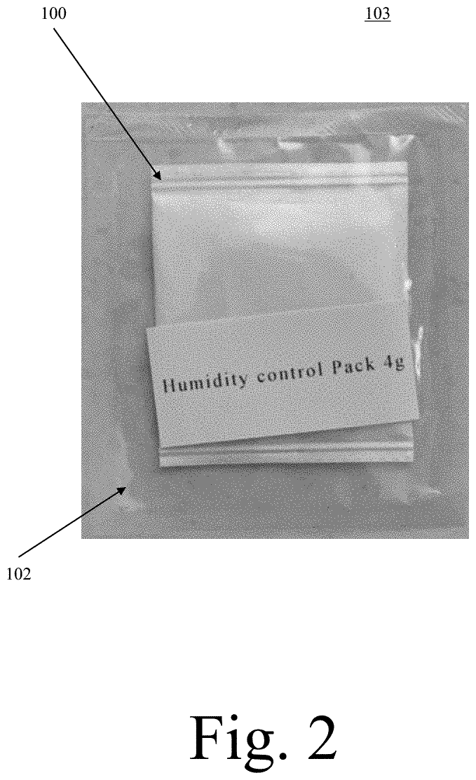

The package holding the contents 103 is made from a polymer material allowing a two-way transference of moisture (which is readily know in the prior art) and the release of the terpenes. Packages with be available in various sizes to suit different average herb content weight. One embodiment of the present invention uses TYVEK paper. FIG. 2 illustrates a humidity control pack, packaged for sale, as taught by the present invention.

In one embodiment, the present invention is sold in 62% RH. However, it is the industry standard to offer 62% or 58% for a Cannabis flower as that tends to suit what most people consider ideal. Depending on market demand the inventions will also offer 58% RH as an option in the future.

Different terpenes offer varying effects and flavors. By using various terpenes, such as Limonene, the inventors can increase the Citrus aroma, flavor, and taste within the Cannabis flower it binds to. Terpenes such as Linalool, as found in Lavender is known to aid in relaxation. The inventors have lab confirmed results that show the terpene levels are increasing about 100-500% after using the product taught by the present invention.

Additional terpene compounds that the Inventor is contemplating using includes, but is not limited to: Myrcene, Beta Caryophyllene, Alpha Pinene, Beta Pinene, Humulene Alpha, Beta Pinene, Ocimene, Limonene, Linalool, Terpinolene, Caryophyllene Oxide, Alpha Bisabolol, Phytol, Nerolidol, and Geranyl Acetate.

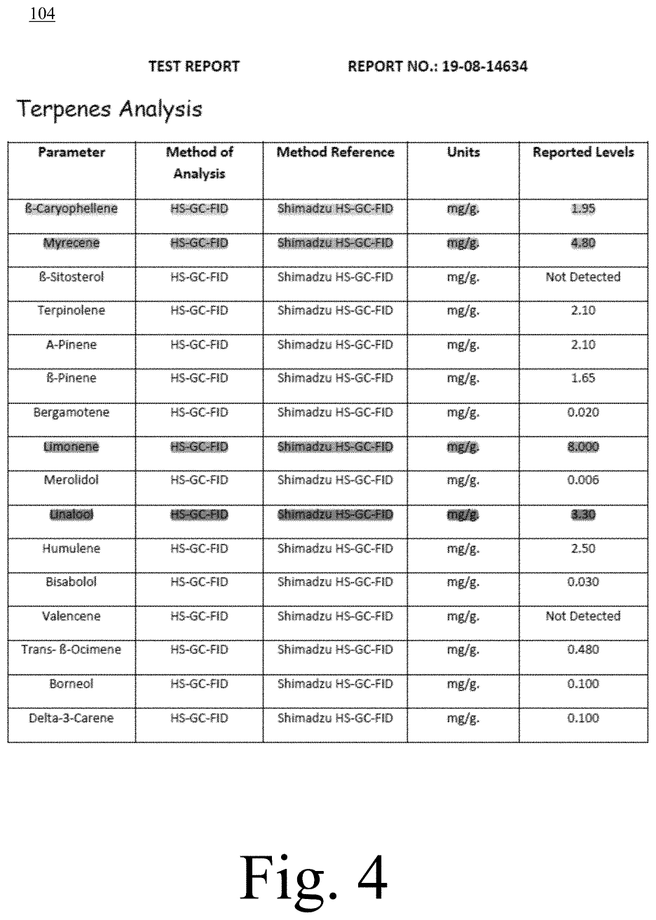

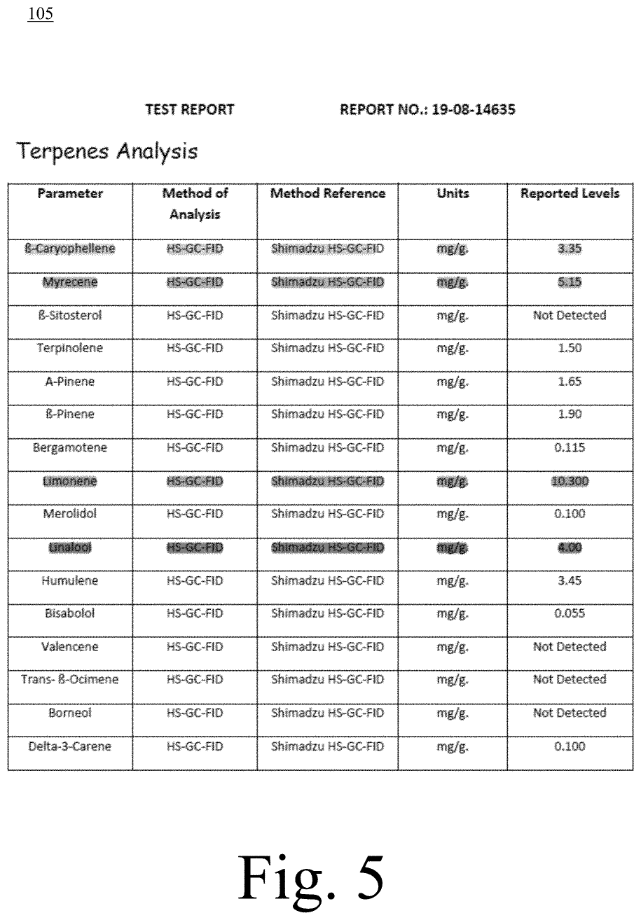

Now referring to FIGS. 4 and 5, lab results and reports have been conducted through an independent lab to confirm effectiveness of the present invention. FIG. 4 represents the control sample of an “un-boosted” flower 104. FIG. 5 illustrates the lab results of the terpene analysis results from the “boosted” flower 105.

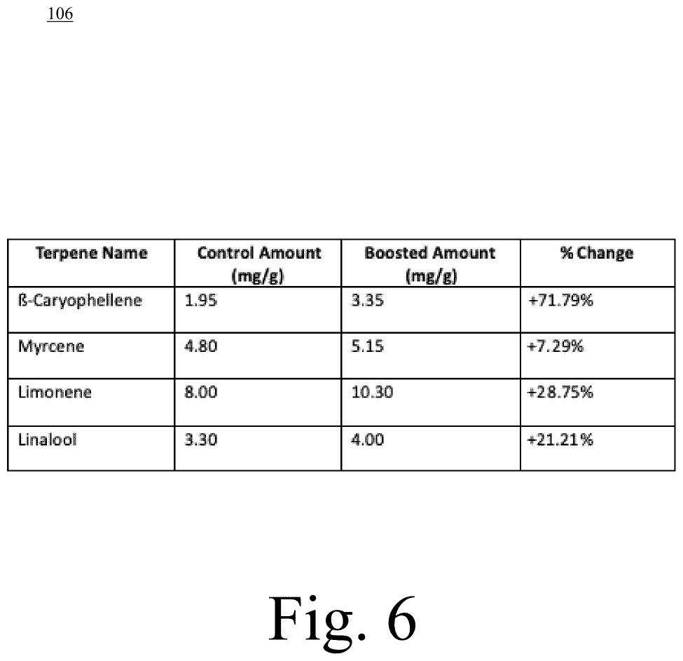

As a result of the inventors' efforts, their invention has confirmed that the highlighted terpenes in FIGS. 4 and 5, which should have resulted in an increase of terpene content, have indeed had that effect. As shown in FIGS. 4-5, β-caryophyllene, Myrcene, Limonene, and Linalool are the main terpenes which were added to the terpene-boosting-humidity-pack (“Terp Pack+RH”), and in fact have been increased unexpectedly as per the numbers/results on the terpene table 106 shown in FIG. 6 showing the unexpected results of β-caryophyllene, Myrcene, Limonene, and Linalool in comparison to other possible terpenes.

Additional terpene compounds that the Inventor is contemplating using includes, but is not limited to: Myrcene, Beta Caryophyllene, Alpha Pinene, Beta Pinene, Humulene Alpha, Beta Pinene, Ocimene, Limonene, Linalool, Terpinolene, Caryophyllene Oxide, Alpha Bisabolol, Phytol, Nerolidol, and Geranyl Acetate.

The present invention teaches various formulations, where the top 6-10 terpenes are used as ingredients, in all of the variations, will be the same ones, just in different percentages.

At the present time, there is no exact mixture, as there will be a few variations for different effects; Sleep, Calming, Uplifting, Focus, Energizing etc., each one having a different formulation. The inventors are still in the process of testing the formulations they will use.

In production, the humidity pack 103 used by the present invention, to which the inventors are adding terpenes into consists of an outside breathable bag 100 made from TYVEK paper and inside a cotton pulp pad 101 as shown in FIGS. 1-3, which is soaked in the following: CMC (Carboxymethyl cellulose (CMC) or cellulose gum): Weight <5%; CAS NO: 9004-32-4; Xanthan Gum: Weight <5%, CAS NO: 11138-66-2; Sodium Lactate: Weight <30%, CAS NO: 72-17-3; Sodium Formate: Weight <20%; CAS NO: 141-53-7; and Water: Weight >20% CAS NO: 7732-18-5.

At the completion of manufacturing of a standard humidity pack 103, the manufacturer then adds approximately four to six drops (where 1 drop=0.0277 ml.) of the inventors desired terpene blend onto each pulp pad 101 before sealing it in the breathable bag 100 and then again in a re-sealable bag 102 to keep the scent and freshness inside.

FIGS. 1 and 3 illustrate a humidity control pack (“Terp Pack+RH”) infused with terpenes as taught by the present invention.

FIG. 2 illustrates a humidity control pack, packaged for sale, as taught by the present invention.

FIGS. 7-9 illustrate specifically the pulp pad pack that is formulated with humidity regulating ingredients and terpene blends, creating a humidity control pack with terpene blends, as taught by the present invention.

The inventors anticipate making larger sizes, to which they will add more drops of terpenes or other ingredients. Standard size will be 4 drops, a Large sized will be 6 drops, and XL will be approx. 12 drops (where 1 drop=0.0277 ml.). The inventors are still testing the levels on the larger sizes as they will initially roll out only the standard size in the marketplace while testing and developing other size variations as it is not obvious that simply increasing size and drop number in proportions is the best solution for scalability.

With two-way humidity control, as humidity is released from the humidity pack 103, terpenes become airborne and combine with the Cannabis flower.

The present invention teaches two main embodiments, the delivery of the terpene mixture via a humidity pack 103 or the delivery of the terpene mixture via a blank pad which looks the same as the humidity packs, except smaller and does not contain any of the chemicals that make it humidify/de-humidify.

In the first embodiment, the humidity pack 103 is just the instrument for delivering the terpenes to the flower. The invention is directed not only to the method of delivery, but also to the idea of infusing terpenes into Cannabis by means of absorption/infusion specific different blends of the terpenes.

The inventors are combining terpenes into a type of humidity regulating pack 103 for use in Cannabis and onto a blank pack with a similar appearance to a humidity pack 103 for inclusion with a Cannabis flow during storage. FIG. 2 illustrates a humidity control pack, packaged for sale, as taught by the present invention. FIGS. 7-9 illustrate specifically the pulp pad pack that is formulated with humidity regulating ingredients and terpene blends, creating a humidity control pack with terpene blends, as taught by the present invention.

For the humidity control pack Terp Pack+RH as illustrated in FIGS. 1 and 3, the inventors have found, unexpectantly through testing, that they needed to use a bigger pulp pad/pack 101 inside the outer breathable bag 100 to soak up more of the terpene blend and humidity regulating ingredients when its being used in larger quantities.

For example, the inventions standard size supports 4 grams of flower; bigger sizes will become available in 8 grams and 64 gram sizes.

The prior art already teaches using additional sizes, so it is not unexpected that the invention would have to use a bigger pulp pad 101 for the RH function. It was unexpected that the present invention did not need to increase the pulp pad 101 if it was only infused with terpenes and not RH.

For the Terp Pack only without the Relative Humidity function (“Terp Pack”) the package 103 and pulp pad/pack 101 stays the same size irrelevant of the amount of flower it is going to be used with since the present invention does not need to soak up extra RH ingredients. The only thing that changes is the amount of terpenes dripped onto the pulp pad/pack 102 as shown in FIGS. 7-9

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A cotton pulp pad/pack carrier for releasing a terpene mixture to a Cannabis flower during storage, the pulp pad/pack device comprising:
a cotton pad;
the cotton pad containing a blend of humidity regulating agents infused with terpenes.

2. The pad carrier device of claim 1, wherein the humidity regulating agents include organic based material.

3. The pad carrier device of claim 1, further comprising an infusion of plant derived terpenes.

4. The pad carrier device of claim 1, wherein
the pad/pack contains no humidity enhancing material and is only a carrier for releasing the terpene mixture.

5. The device of claim 3, wherein
the combined two-way humidity pack containing an herban material.

6. The device of claim 1, further comprising
adding terpene blends into the humidity pack so the terpene levels in a Cannabis flower are not only re-humidified but also get an addition and increase in the desired terpene levels.

7. The device of claim 6, wherein
the package holding the contents is made from a polymer material allowing a two-way transference of moisture and the release of the terpenes.

8. The device of claim 1, wherein
packages of varying sizes to suit different average herb content weight.

9. The device of claim 1, wherein
the device uses TYVEK paper.

10. The device of claim 1, wherein the Terpenes are selected from a group comprising:
β-caryophyllene,
Myrcene,
Limonene;
Linalool Myrcene;
Beta Caryophyllene;
Alpha Pinene;
Beta Pinen;
Humulene Alpha;
Beta Pinene;
Ocimene;
Linalool;
Terpinolene;
Caryophyllene Oxide;
Alpha Bisabolol;
Phytol, Nerolidol; and
Geranyl Acetate.

11. The device of claim 10, wherein
one or more terpenes from the terpenes group used as ingredients; and
in all of the variations, the terpenes selected will be from the same group, but in different and varying percentages.

12. A two-way humidity pack or releasing a terpene mixture to a Cannabis flower during storage, the device comprising:
one or more terpene compounds applied to a cotton pulp pad inside the two-way humidity pack;
the humidity pack and added terpenes pad/pack consists of an outside breathable bag made from TYVEK paper and inside a cotton pulp pad;
the cotton pulp pad is soaked in a terpene blend mixture.

13. The pad carrier device of claim 12, wherein
the humidity regulating agents include organic based material; and
further comprising an infusion of plant derived terpenes.

14. The device of claim 13, wherein the humidity control mixture is comprised of
CMC (Carboxymethyl cellulose (CMC) or cellulose gum): Weight <5%, CAS NO: 9004-32-4;
Xanthan Gum: Weight <5%, CAS NO: 11138-66-2;
Sodium Lactate: Weight <30%, CAS NO: 72-17-3;
Sodium Formate: Weight <20%; CAS NO: 141-53-7; and
Water: Weight >20% CAS NO: 7732-18-5.

15. The device of claim 13, wherein
approximately four to six drops, where 1 drop=0.0277 ml of the terpene blend are dispersed onto each cotton pulp pad before sealing it in the breathable bag; and
each cotton pulp pad located within a first breathable bag is paced in a second, sealed bag.

16. A device for releasing a terpene mixture to a Cannabis flower during storage, the device comprising:
a breathable bag;
a cotton pulp pad;
the cotton pulp pad containing a blend of humidity regulating agents infused with terpenes;
the cotton pulp pad placed inside the breathable bag;
a resealable bag; and
the breathable bag containing the cotton bag.

17. The pad carrier device of claim 16, wherein
the humidity regulating agents include organic based material; and
further comprising an infusion of plant derived terpenes.

18. The device of claim 17, wherein the humidity control mixture is comprised of
CMC (Carboxymethyl cellulose (CMC) or cellulose gum): Weight <5%, CAS NO: 9004-32-4;
Xanthan Gum: Weight <5%, CAS NO: 11138-66-2;
Sodium Lactate: Weight <30%, CAS NO: 72-17-3;
Sodium Formate: Weight <20%; CAS NO: 141-53-7; and
Water: Weight >20% CAS NO: 7732-18-5.

19. The device of claim 17, wherein the Terpenes are selected from a group comprising:
β-caryophyllene,
Myrcene,
Limonene;
Linalool Myrcene;
Beta Caryophyllene;
Alpha Pinene;
Beta Pinen;
Humulene Alpha;
Beta Pinene;
Ocimene;
Linalool;
Terpinolene;
Caryophyllene Oxide;
Alpha Bisabolol;
Phytol, Nerolidol; and
Geranyl Acetate.

20. The device of claim 16, wherein
approximately 0.08 to 0.18 ml of the terpene blend are dispersed onto each cotton pulp pad before sealing it in the breathable bag; and
each cotton pulp pad located within a first breathable bag is paced in a second, sealed bag.
